(19) United States
(12) Patent Application Publication
(10) Pub. No.: US 2013/0285476 A1
(43) Pub. Date: Oct. 31, 2013

(54) POWER SUPPLY DEVICE, INVERTER DEVICE, POWER TOOL

(71) Applicants: Yasushi Nakano, Hitachinaka (JP); Kazuhiko Funabashi, Hitachinaka (JP); Yoshikazu Kawano, Hitachinaka (JP); Shinji Watanabe, Hitachinaka (JP); Miyoji Onose, Hitachinaka (JP); Haruhisa Fujisawa, Hitachinaka (JP)

(72) Inventors: Yasushi Nakano, Hitachinaka (JP); Kazuhiko Funabashi, Hitachinaka (JP); Yoshikazu Kawano, Hitachinaka (JP); Shinji Watanabe, Hitachinaka (JP); Miyoji Onose, Hitachinaka (JP); Haruhisa Fujisawa, Hitachinaka (JP)

(73) Assignee: HITACHI KOKI CO LTD, TOKYO (JP)

(21) Appl. No.: 13/978,572

(22) PCT Filed: Jan. 16, 2012
(86) PCT No.: PCT/JP2012/000212

§ 371 Date: Jul. 8, 2013

(30) Foreign Application Priority Data
Jan. 14, 2011 (JP) 2011-006445

(51) Int. Cl. H02M 7/44

(52) U.S. Cl. CPC H02M 7/44
USPC 307/150

(57) ABSTRACT

A power supply device includes: a battery pack; a transforming unit configured to transform a DC voltage supplied from the battery pack; and a control unit configured to determine, based on a characteristic of the battery pack, whether or not the converting unit performs an outputting operation.

### TECHNICAL FIELD

The present invention relates to a power supply device, an inverter device, and a power tool provided with the power supply device or the inverter device.

### BACKGROUND ART

An electronic device provided with an inverter circuit is well-known. Such the electronic device boosts AC voltage supplied from a commercial power source, rectifies/smoothes the boosted AC voltage into DC voltage, converts the DC voltage into predetermined AC voltage using the inverter circuit, and outputs the predetermined AC voltage to an AC motor provided in the electronic device.

Japanese Patent Application Publication No. 2009-278832 provides a technique that operates the AC motor provided in the electronic device with DC voltage supplied from a battery pack instead of the AC voltage supplied from the commercial power source.

In the above technique, an inverter device provided with a converting circuit, a booster circuit, a rectifying/smoothing circuit, and an inverter circuit are connected between the battery pack and the electronic device to supply AC power to the electronic device.

### DISCLOSURE OF INVENTION

### Solution to Problem

However, since battery packs have characteristics different from one another, there is a danger that the life and outputting efficiency of the battery pack could be drastically degraded by attempting to draw the same amount of power from all battery packs.

In view of the foregoing, it is an object of the present invention to provide a power supply device capable of preventing a drastic reduction in a service life of a battery pack.

In order to attain the above and other objects, the invention provides a power supply device including: a battery pack; a transforming unit configured to transform a DC voltage supplied from the battery pack; and a control unit configured to determine, based on a characteristic of the battery pack, whether or not the converting unit performs an outputting operation.

It is preferable that the control unit prevents the converting unit from performing the outputting operation when the characteristic of the battery back is not adapted to the power supply device.

It is preferable that the transforming unit comprises a booster configured to boost the DC voltage supplied from the battery pack. The control unit prevents the booster from performing a boosting operation when the characteristic of the battery back is not adapted to the power supply device.

It is preferable that the transforming unit further includes: a rectifying/smoothing circuit configured to rectifies/smoothes a voltage outputted from the booster; and an inverter circuit configured to convert a voltage outputted from the rectifying/smoothing circuit into an AC voltage. The control unit prevents at least one of the booster from performing the boosting operation and the inverter circuit from performing a converting operation when the characteristic of the battery back is not adapted to the power supply device.

It is preferable that the control unit prevents the booster from performing the boosting operation based on a rating capacity of the battery pack.

It is preferable that the control unit prevents the booster from performing the boosting operation based on a rated voltage of the battery pack.

Another aspect of the present invention provides an inverter device including: a converting unit configured to convert a first DC power supplied from a battery pack into a first AC power and output the first AC power; a rectifying/smoothing circuit configured to convert the first AC power into a second DC power and output the second DC power; an inverter circuit configured to convert the second DC power into a second AC power and output the second AC power; and a control unit configured to prevent at least one of the converting unit from outputting the first AC power and the inverter circuit from outputting the second AC power based on a characteristic of the battery pack.

It is preferable that the control unit prevents at least one of the converting unit from outputting the first AC power and the inverter circuit from outputting the second AC power based on a rating capacity of the battery pack.

It is preferable that the battery back includes at least one battery cell, and the control unit prevents at least one of the converting unit from outputting the first AC power and the inverter circuit from outputting the second AC power based on a parallel number of the battery cell.

It is preferable that the control unit prevents at least one of the converting unit from outputting the first AC power and the inverter circuit from outputting the second AC power based on a rated voltage of the battery pack.

It is preferable that the battery back includes at least one battery cell, and the control unit prevents at least one of the converting unit from outputting the first AC power and the inverter circuit from outputting the second AC power based on a type of the battery cell.

Another aspect of the present invention provides a power tool including: the power supply device; and an AC motor driven with the second AC power.

Another aspect of the present invention provides a power tool including: the inverter device; and an AC motor driven with the second AC power.

### Advantageous Effects of Invention

The power supply device of the present invention can prevent a drastic reduction in a service life of a battery pack.

### BRIEF DESCRIPTION OF DRAWINGS

[FIG. 1]

FIG. 1 is a circuit diagram of an inverter device according to a preferred embodiment of the present invention.

[FIG. 2]

FIG. 2 is a flowchart illustrating steps in a process for preventing output from the inverter device according to the preferred embodiment.

### REFERENCE SIGNS LIST

1 Inverter device
14 Rectifying/smoothing circuit
16 Inverter circuit
19 Control unit
2 Battery pack
2a Battery cell
3 Electronic device

### BEST MODE FOR CARRYING OUT THE INVENTION

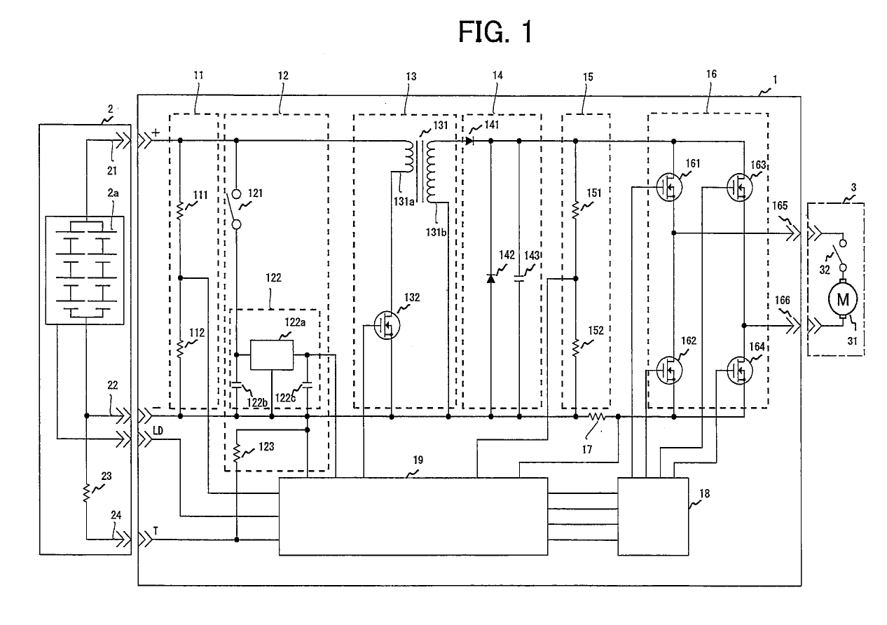

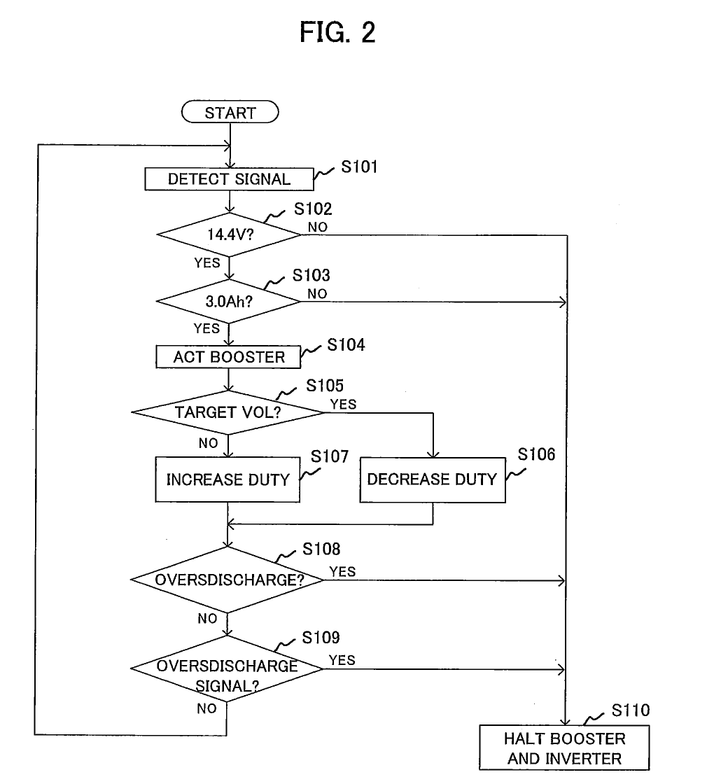

An inverter device 1 according to a preferred embodiment of the power supply device of the present invention will be described while referring to FIGS. 1 and 2.

FIG. 1 is a circuit diagram for the inverter device 1. The inverter device 1 is connected between a battery pack 2 and an electronic device 3 to convert a DC power supplied from the battery pack 2 into an AC power and outputs the AC power to an AC motor 31 provided in the electronic device 3. When an operator operates a trigger switch 32 provided in the electronic device 3, the inverter device 1 converts DC power supplied from the battery pack 2 to AC power and supplies this AC power to the AC motor 31 of the electronic device 3. While the inverter device 1, electronic device 3, and battery pack 2 are detachably connected to one another, the following description assumes that these components are connected. The electronic device 3 includes a power tool driven with 100V of AC voltage, such as a lawn.

The battery pack 2 has four 3.6-V lithium battery cells 2a connected in series for outputting a rated voltage of 14.4 V. Further, the battery pack 2 includes a first battery characteristic determining resistor 23 having a resistance value that corresponds to the characteristics of the battery pack 2, and a battery characteristic outputting terminal 24. Battery packs 2 having differing characteristics can be mounted on the inverter device 1. In the preferred embodiment, the battery characteristics includes the number of parallel of battery cells 2a, the rated voltage, and the type of the battery cells 2a, although not limited to these examples.

The inverter device 1 includes a battery voltage detection unit 11, a power supply unit 12, a booster circuit 13, a rectifying/smoothing circuit 14, a boost voltage detection unit 15, an inverter circuit 16, a current detection resistor 17, a PWM signal output unit 18, and a control unit 19.

The battery voltage detection unit 11 includes battery voltage detection resistors 111 and 112. The battery voltage detection resistors 111 and 112 are connected in series between a plus terminal 21 and a minus terminal 22 of the battery pack 2 to output a divided voltage of the battery voltage of the battery pack 2 by the battery voltage detection resistors 111 and 112 to the control unit 19.

The power supply unit 12 includes a power switch 121 and a constant-voltage circuit 122 connected in series between the plus terminal 21 of the battery pack 2 and the control unit 19. The constant-voltage circuit 122 includes a three-terminal regulator 122a, and oscillation-prevention capacitors 122b and 122c. When an operator turns on the power switch 121, the constant-voltage circuit 122 converts the voltage supplied from the battery pack 2 into a prescribed DC voltage (5 V, for example) and supplies this voltage to the control unit 19 as drive voltage. When the operator switches off the power switch 121, the entire inverter device 1 is turned off because the drive voltage is no longer supplied to the control unit 19.

Further, the power supply unit 12 includes a second battery characteristic determining resistor 123. The second battery characteristic determining resistor 123 is connected between the three-terminal regulator 122a and the minus terminal 22 of the battery pack 2 and the minus terminal 22 via the battery characteristic outputting terminal 24. The second battery characteristic determining resistor 123 and the first battery characteristic determining resistor 23 divide a prescribed voltage outputted from the three-terminal regulator 122a (5 V in the preferred embodiment), and output this divided voltage to the control unit 19. Since the resistance value of the first battery characteristic determining resistor 23 differs according to the characteristics of the battery pack 2, the control unit 19 can determine the characteristics of the battery pack 2 based on the divided voltage inputted from the power supply unit 12 and can output an identification signal that identifies these characteristics (the battery type).

The booster circuit 13 is configured of a transformer 131, and a field effect transistor (FET) 132 that serves as the converting unit. The transformer 131 includes a primary winding 131a, and a secondary winding 13 lb. The primary winding 131a is connected between the plus terminal 21 and minus terminal 22 of the battery pack 2. The FET 132 is provided between the primary winding 131 a of the transformer 131 and the minus terminal 22 of the battery pack 2. The control unit 19 inputs a first PWM signal into the gate of the FET 132 for switching the FET 132 on and off. Through on/off switching of the FET 132, the DC power supplied from the battery pack 2 to the primary winding 131 a of the transformer 131 is converted into AC power. The AC voltage of this AC power is stepped up based on the ratio of the number of turns in the secondary winding 131b to the number of turns in the primary winding 131a, and is outputted from the secondary winding 131b.

The rectifying/smoothing circuit 14 is configured of rectifying diodes 141 and 142, and a smoothing capacitor 143. Through this configuration, the rectifying/smoothing circuit 14 converts the AC voltage stepped up by the transformer 131 to DC voltage (141 V, for example).

The boost voltage detection unit 15 includes resistors 151 and 152 connected in series to output a divided voltage of the DC voltage outputted from the rectifying/smoothing circuit 14 (the voltage at the smoothing capacitor 143; 141 V, for example) by the resistors 151 and 152 to the control unit 19.

The inverter circuit 16 is configured of four FETs 161-164. The FETs 161 and 162 are connected in series, and the FETs 163 and 164, with both pairs of FETs being connected to the smoothing capacitor 143 in parallel. More specifically, the drain of the FET 161 is connected to the cathodes of the rectifying diodes 141 and 142, while the source of the FET 161 is connected to the drain of the FET 162. Similarly, the drain of the FET 163 is connected to the cathodes of the rectifying diodes 141 and 142, while the source of the FET 163 is connected to the drain of the FET 164.

The inverter circuit 16 also includes output terminals 165 and 166 that are connected to the AC motor 31 of the power tool 3. The source of the FET 161 and the drain of the FET 162 are connected to the output terminal 165, while the source of the FET 163 and the drain of the FET 164 are connected to the output terminal 166. The PWM signal output unit 18 outputs second PWM signals to the gates of the FETs 161-164 for switching the FETs 161-164 on and off. Through on/off switching of the FETs 161-164, the inverter circuit 16 converts the DC power outputted from the rectifying/smoothing circuit 14 into AC power and supplies this AC power to the power tool 3 (the AC motor 31).

The current detection resistor 17 is connected between the source of the FET 162 (FET 164) and the minus terminal 22 of the battery pack 2. The terminal of the current detection resistor 17 on the high-voltage side is also connected to the control unit 19. With this configuration, the control unit 19 can determine the current flowing to the AC motor 31 based on the voltage detected by the current detection resistor 17.

The control unit 19 outputs the first PWM signal to the gate of the FET 132 based on the boosted voltage detected by the boost voltage detection unit 15 in order that the AC voltage outputted from the secondary side of the transformer 131 has the desired effective voltage (141 V, for example). The control unit 19 also outputs the second PWM signals to the gates of the FETs 161-164 via the PWM signal output unit 18 in order that the AC voltage outputted to the AC motor 31 has the desired effective voltage (100 V, for example). In the preferred embodiment, the FETs 161 and 164 are treated as one set (hereinafter referred to as the “first set”), while the FETs 162 and 163 are treated as another set (hereinafter referred to as the “second set”), and the control unit 19 outputs the second PWM signals for alternately turning on and off the first and second sets at a duty cycle of 100%.

The control unit 19 also determines whether over-discharge has occurred in the battery pack 2 based on the battery voltage detected by the battery voltage detection unit 11. More specifically, when the battery voltage detected by the battery voltage detection unit 11 is smaller than a prescribed over-discharge voltage, the control unit 19 determines that over-discharge has occurred in the battery pack 2 and outputs the first and second PWM signals in order to halt output to the AC motor 31. That is, the control unit 19 halts output of the first and second PWM signals.

The battery pack 2 is further provided with a built-in protection circuit or microcomputer and possesses a function for self-detecting over-discharge and for outputting an over-discharge signal to the control unit 19. When the control unit 19 receives an over-discharge signal from the battery pack 2 via a signal terminal LD, the control unit 19 outputs first and second PWM signals in order to halt output to the AC motor 31. That is, the control unit 19 halts output of the first and second PWM signals. This construction can prevent such over-discharge from shortening the lifespan of the battery pack 2.

Here, while battery packs 2 having differing characteristics can be connected to the inverter device 1 in the preferred embodiment, there is a danger that the life and outputting efficiency of the battery pack 2 could be drastically degraded by attempting to draw the same amount of power from all battery packs 2. For example, when attempting to draw the same current from a battery pack 2 having battery cells connected in a single series as from a battery pack 2 having cells connected in two parallel series, the current flowing in the former will be twice that flowing in the latter, potentially reducing the service life of the battery pack 2 configured of a single series of battery cells. Further, since the rated current of the battery pack 2 differs according to its type, the service life of the battery pack 2 could be reduced for the same reason.

Normally, the ratio of turns on the secondary winding to the turns on the primary winding of a transformer is set to a value for obtaining maximum conversion efficiency when a prescribed voltage is applied. Hence, when a battery pack 2 having a rated voltage different from this prescribed voltage is connected to the inverter device 1, the conversion efficiency of the transformer 131 may drop drastically. This drop in efficiency may lead to a rise in temperature in the inverter device 1, requiring a cooling fan or the like and, therefore, increasing the size of the inverter device 1.

Accordingly, the inverter device 1 according to the preferred embodiment controls voltage outputted from the inverter device 1 to the AC motor 31 based on a battery characteristic identification signal obtained from the battery characteristic outputting terminal 24 (first battery characteristic determining resistor 23). Specifically, the inverter device 1 outputs first and second PWM signals to prevent the FET 132 and FETs 161-164 from being turned on/off.

Next, the control process performed by the control unit 19 according to the preferred embodiment for halting output to the AC motor 31 will be described with reference to the flowchart in FIG. 2.

The control unit 19 begins the process in FIG. 2 either when the power switch 121 is turned on while the battery pack 2 is mounted on the inverter device 1 or when the battery pack 2 is mounted on the inverter device 1 while the power switch 121 is in an ON state. When the power switch 121 is turned on, the constant-voltage circuit 122 generates a drive voltage for driving the control unit 19 from the battery voltage of the battery pack 2.

The inverter device 1 according to the preferred embodiment has a configuration suited for supplying power from a battery pack 2 having a rated voltage of 14.4 V and a rated capacity of 3.0 Ah (two series of cells connected in parallel).

In S101 of the flowchart in FIG. 2, the control unit 19 detects the battery characteristic identification signal received from the first battery characteristic determining resistor 23 and second battery characteristic determining resistor 123. In S102 the control unit 19 determines whether the rated voltage of the battery pack 2 connected to the inverter device 1 is 14.4 V based on the battery characteristic identification signal.

If the battery pack 2 is not 14.4 V but, for example, is an 18.0 V battery pack (S102: NO), in S110 the control unit 19 outputs the first and second PWM signals for preventing power from being outputted from the inverter device 1 to the AC motor 31. Specifically, the control unit 19 halts output of the first and second PWM signals, thereby halting operations of the booster circuit 13 and inverter circuit 16 and interrupting output from the inverter device 1 to the AC motor 31.

As described above, the transformer 131 is set to have optimum power efficiency when the battery pack 2 connected to the inverter device 1 has a rated voltage of 14.4 V. Since output efficiency is reduced if an 18.0 V battery pack is connected, it may not be possible to obtain the desired output. Therefore, this operation serves to interrupt output to the AC motor 31 in such a case.

However, when the connected battery pack 2 has a rated voltage of 14.4 V (S102: YES), in S103 the control unit 19 determines whether the battery pack 2 has a rated capacity of 3.0 Ah based on the battery characteristic identification signal.

If the battery pack 2 does not have a 3.0 Ah rated capacity (S103: NO), in S110 the control unit 19 outputs the first and second PWM signals for preventing power from being outputted from the inverter device 1 to the AC motor 31. Specifically, the control unit 19 halts output of the first and second PWM signals.

As described above, the inverter device 1 is configured to achieve optimal use with battery packs having a rated capacity of 3.0 Ah (battery cells connected in two parallel series). When the connected battery pack has a rated capacity of 1.5 Ah (is configured of a single series of cells), an electric current twice the magnitude of that flowing in a battery pack with two parallel series of cells will be produced when attempting to draw the same power as when the connected battery pack has a rated capacity of 3.0 Ah. This large current can shorten the life of the battery pack and potentially damage the FET 132.

However, when the battery pack 2 connected to the inverter device 1 has a rated capacity of 3.0 Ah (S103: YES), the control unit 19 begins outputting power to the AC motor 31 since the connected battery pack 2 is suited for the inverter device 1 of the preferred embodiment.

Specifically, in S104 the control unit 19 outputs the first PWM signal to the gate of the FET 132 in order that the AC power outputted from the secondary side of the transformer 131 has the desired effective voltage (101 V, for example). In S105 the control unit 19 determines whether the effective voltage boosted by the transformer 131 is greater than the target voltage based on the voltage detected by the boost voltage detection unit 15.

If the boosted voltage is greater than the target voltage (S105: YES), in S106 the control unit 19 reduces the duty cycle of the FET 132. When the boosted voltage is less than or equal to the target voltage (S105: NO), in S107 the control unit 19 increases the duty cycle of the FET 132.

In S108 the control unit 19 determines whether the battery voltage of the battery pack 2 is less than a prescribed over-discharge voltage based on the voltage detected by the battery voltage detection unit 11. If the battery voltage is less than the prescribed over-discharge voltage (S108: YES), then the control unit 19 determines that the battery pack 2 is in an over-discharge state. Accordingly, in S110 the control unit 19 outputs first and second PWM signals for halting output to the AC motor 31. Specifically, the control unit 19 halts output of the first and second PWM signals. As a result, operations of the booster circuit 13 and inverter circuit 16 are shut down, thereby halting output from the inverter device 1 to the AC motor 31.

However, if the battery voltage of the battery pack 2 is greater than or equal to the prescribed over-discharge voltage (S108: NO), in S109 the control unit 19 determines whether an over-discharge signal was inputted from the battery pack 2 via the LD terminal. If an over-discharge signal was inputted (S109: YES), then the control unit 19 determines that the battery pack 2 is in an over-discharge state. Accordingly, in S110 the control unit 19 outputs the first and second PWM signals for halting output to the AC motor 31. Specifically, the control unit 19 halts output of the first and second PWM signals.

However, if an over-discharge signal was not inputted (S110: NO), the control unit 19 returns to S101.

As described above, the inverter device 1 according to the preferred embodiment halts operations of the booster circuit 13 and inverter circuit 16 according to the battery characteristic identification signal obtained from the first battery characteristic determining resistor 23. Therefore, the inverter device 1 can prevent a drastic reduction in the service life and output efficiency of the battery pack 2 when a battery pack 2 not suitable for the inverter device 1 is connected thereto.

For example, when a battery pack 2 configured of a single series of cells is connected to the inverter device 1, the structure of the inverter device 1 described above can avoid reducing the service life of the battery pack 2.

The configuration of the inverter device 1 described above can also avoid reducing the service life of a battery pack 2 that is different from the prescribed type when such a battery pack 2 is connected to the inverter device 1.

The inverter device 1 having the above configuration can also prevent a drop in conversion efficiency of the transformer 131 when the battery pack 2 connected to the inverter device 1 does not have the prescribed rated voltage (18 V, for example).

While the invention has been described in detail with reference to the preferred embodiments thereof, it would be apparent to those skilled in the art that various changes and modifications may be made therein without departing from the spirit of the invention.

In the preferred embodiment described above, the inverter device 1 prevents the FET 132 and FETs 161 and 164 from being turned on/off according to the battery characteristic identification signal obtained from the first battery characteristic determining resistor 23. However, the inverter device 1 may be configured to prevent only one of the FET 132 and the FETs 161-164 from being turned on/off instead.

The inverter device 1 according to the preferred embodiment determines the type of battery pack 2 connected to the inverter device 1 using the first battery characteristic determining resistor 23 disposed in the battery pack 2 and the second battery characteristic determining resistor 123 disposed in the inverter device 1. However, the inverter device 1 is not limited to this method of determination, provided that the inverter device 1 can distinguish between battery packs that the inverter device 1 supports and does not support.

For example, the inverter device 1 may be configured to determine battery packs that are supported by the inverter device 1 based on the presence of an identification terminal connecting the battery pack to the inverter device 1, where battery packs possessing a terminal other than a charging/discharging terminal (an identification terminal) are supported, while those not possessing an identification terminal are not supported. Alternatively, the connectors of batteries and inverter devices (parts for connecting the inverter devices to battery packs) may be shaped differently according to type so that battery packs that are mechanically unusable cannot be mounted on (connected to) the inverter device.

Further, the battery pack 2 that is connected to the inverter device 1 in the preferred embodiment described above is a 14.4 V lithium battery pack, but the inverter device 1 may be configured to prevent output according to different types of battery packs in addition to those housing lithium batteries, such as battery packs configured of nickel cadmium batteries or nickel metal hydride batteries, or may be configured to support battery packs with different voltages (18 V, for example).

Further, the processes for controlling the boosted voltage in S104-S107 and for detecting over-discharge in S108-S109 in the flowchart of FIG. 2 may be performed at any position in the flowchart or may be performed in parallel.

In the flowchart of FIG. 2, an overcurrent detection may be further performed. Specifically, the control unit 19 halts the operations of the booster circuit unit 13 and inverter circuit 16 when the current detected by the current detection resistor 17 has exceeded a predetermined current. With this construction, it can prevented that the battery pack 2, the AC motor 32, and FETs 132 and 161-164 are damaged due to the heat generated by the overcurrent.

1. A power supply device comprising:
a battery pack;
a transforming unit configured to transform a DC voltage supplied from the battery pack; and
a control unit configured to determine, based on a characteristic of the battery pack, whether or not the converting unit performs an outputting operation.

2. The power supply device according to claim 1, wherein the control unit prevents the converting unit from performing the outputting operation when the characteristic of the battery back is not adapted to the power supply device.

3. The power supply device according to claim 1, wherein the transforming unit comprises a booster configured to boost the DC voltage supplied from the battery pack, and wherein the control unit prevents the booster from performing a boosting operation when the characteristic of the battery back is not adapted to the power supply device.

4. The power supply device according to claim 3, wherein the transforming unit further comprises:
a rectifying/smoothing circuit configured to rectifies/smoothes a voltage outputted from the booster; and
an inverter circuit configured to convert a voltage outputted from the rectifying/smoothing circuit into an AC voltage,
wherein the control unit prevents at least one of the booster from performing the boosting operation and the inverter circuit from performing a converting operation when the characteristic of the battery back is not adapted to the power supply device.

5. The power supply device according to claim 3, wherein the control unit prevents the booster from performing the boosting operation based on a rating capacity of the battery pack.

6. The power supply device according to claim 3, wherein the control unit prevents the booster from performing the boosting operation based on a rated voltage of the battery pack.

7. An inverter device comprising:
a converting unit configured to convert a first DC power supplied from a battery pack into a first AC power and output the first AC power;
a rectifying/smoothing circuit configured to convert the first AC power into a second DC power and output the second DC power;
an inverter circuit configured to convert the second DC power into a second AC power and output the second AC power; and
a control unit configured to prevent at least one of the converting unit from outputting the first AC power and the inverter circuit from outputting the second AC power based on a characteristic of the battery pack.

8. The inverter device according to claim 7, wherein the control unit prevents at least one of the converting unit from outputting the first AC power and the inverter circuit from outputting the second AC power based on a rating capacity of the battery pack.

9. The inverter device according to claim 7, wherein the battery back includes at least one battery cell, and the control unit prevents at least one of the converting unit from outputting the first AC power and the inverter circuit from outputting the second AC power based on a parallel number of the battery cell.

10. The inverter device according to claim 7, wherein the control unit prevents at least one of the converting unit from outputting the first AC power and the inverter circuit from outputting the second AC power based on a rated voltage of the battery pack.

11. The inverter device according to claim 7, wherein the battery back includes at least one battery cell, and the control unit prevents at least one of the converting unit from outputting the first AC power and the inverter circuit from outputting the second AC power based on a type of the battery cell.

12. A power tool comprising:
the power supply device according to any one of claims 1-6; and
an AC motor driven with the second AC power.

13. A power tool comprising:
the inverter device according to any one of claims 7-11; and
an AC motor driven with the second AC power.
